(19) United States
(12) Patent Application Publication
(10) Pub. No.: US 2025/0212233 A1
(43) Pub. Date: Jun. 26, 2025

(54) SYSTEM FOR DETECTING A MOTION STATE OF A DEVICE BASED ON RADIO SIGNAL INFORMATION

(71) Applicant: VIETTEL GROUP, Ha Noi City (VN)

(72) Inventors: NGUYEN HUY DAO, Hai Phong City (VN); QUANG DAN CHU, Dien Chau District (VN); VAN TIEN TRAN, Hoang Hoa District (VN); PHUONG NAM LE, Ha Noi City (VN); THI ANH HONG CHU, Ha Noi City (VN)

(73) Assignee: VIETTEL GROUP, Ha Noi City (VN)

(21) Appl. No.: 18/924,895

(22) Filed: Oct. 23, 2024

(30) Foreign Application Priority Data
Dec. 26, 2023 (VN) 1-2023-09265

(51) Int. Cl. H04W 72/30; H04W 84/18

(52) U.S. Cl. CPC H04W 72/30; H04W 84/18

(57) ABSTRACT

A system for effectively determining the motion state of a device based on the quality of radio signals received between scan intervals, comprising the following steps: radio signal reception, elimination of interfering radio signals, and finally, determination of the motion state of device. This novel method is useful for cyclic positioning and monitoring devices. It extends battery life per charge by reducing the occurrence of false motion detections. Additionally, the solution can help reduce hardware costs by eliminating the need for a motion sensor module.

### TECHNICAL AREAS MENTIONED

The invention addresses a system to detect the motion state of a device. Specifically, the system outlined in the disclosure is based on the quality of radio signals received during operational cycles of the device. This system is applied in the fields of positioning and monitoring, aiding in energy conservation and cost reduction for devices.

Technical status of the invention Tracking and monitoring equipment is a type of device that is capable of determining the location. Some prevalent technologies employed by positioning and monitoring devices include Global Navigation Satellite Systems (GNSS), location determination through wireless network signals (WiFi). The location data is subsequently often transmitted to users via mobile networks. The energy consumption of monitoring and tracking devices is primarily associated with the location determination process and the connectivity to mobile network stations for data transmission. In practice, continuous location updates are not always necessary; updates are typically required only when the device moves beyond a specified range, often following a periodic update scheme. The primary goal of this approach is to optimize energy efficiency while maintaining the requisite functionality.

Therefore, positioning devices often incorporate motion sensors to determine whether the device is in motion or stationary. However, motion sensors have certain limitations, and false motion detection is a common issue. Additionally, the hardware of current positioning devices primarily relies on microcontrollers with limited resources, computational power, and battery capacity, which are insufficient for deploying complex algorithms to accurately identify true motion patterns, leading to an increased likelihood of false motion results. When false motion detection occurs, the device expends energy executing location determination functions and connecting to networks to transmit the position of device.

Meanwhile, most positioning and monitoring devices are equipped with wireless network transceivers (WiFi). Based on the aforementioned issues, the authors propose a system to determine whether the device is in motion or stationary by analyzing the quality of the received WiFi signal through periodic scans of radio waves.

### The Technical Nature of the Disclosure

The objective of the invention is to propose a system capable of determining the device's motion state based on the quality of the received wireless network (WiFi) signal, analyzed through signal quality difference of the interval scan. For each operational cycle of the device, to achieve the objective of determining the motion state, the device will sequentially perform the following functional blocks:

Signal reception block: performs scanning of broadcast messages from wireless network (WiFi) access points, extracts key parameters, specifically the MAC address and an index reflecting the quality of the received signal.

Wireless signal removal block: from the set of parameters obtained from the access points, filters out those that are erroneous or irrelevant to the motion state determination process.

Motion state determination block: the most critical block, evaluates and compares the set of wireless network (WiFi) access points between scanning cycles to determine the motion state of the device.

The resulting motion state output will be used as input for subsequent purposes, depending on the developer's needs. This new system eliminates the issue of false motion detection compared to traditional methods relying on motion sensors. The system enables the device to accurately detect its motion state using a microcontroller with limited computational resources, thereby conserving energy.

### BRIEF DESCRIPTION OF THE DRAWINGS

FIG. 1 is a drawing depicting the change in the number of broadcasting stations around the device when the device is at scan times t₁ and t₂;

FIG. 2 is a diagram depicting the blocks that need to be implemented in the proposed system in the invention;

FIG. 3 is a drawing depicting the change in the number of transmitting stations around the device when the device is at position d1 and when the device moves by 200 m to position d₁+200;

FIG. 4 is a drawing depicting the change in the number of broadcasting stations around the device when the device is at position d₁ and when the device moves by 50 m to position d₁+50; and

FIG. 5 is a chart of the experimental results to select standard parameters to determine the moving state of the device.

### DETAILED DESCRIPTION

The following section describes the detailed steps for implementing the system through interpretation and accompanying diagrams.

The fundamental principle of the system is illustrated in FIG. 1. Signal sources (e.g., WiFi, Bluetooth, etc.) continuously broadcast signals. These signals are omnidirectional and transmitted to receiving devices within a permissible range, with the transmission distance varying depending on the radio technology used. Devices within the coverage area of the signal sources will capture the broadcast messages from these sources. This signal enables the device to determine two critical parameters: the number of access points in the vicinity and the quality of the signal at that specific location and time. Based on the number of access points and the quality of the received signal, it is possible to determine whether the device has moved or not.

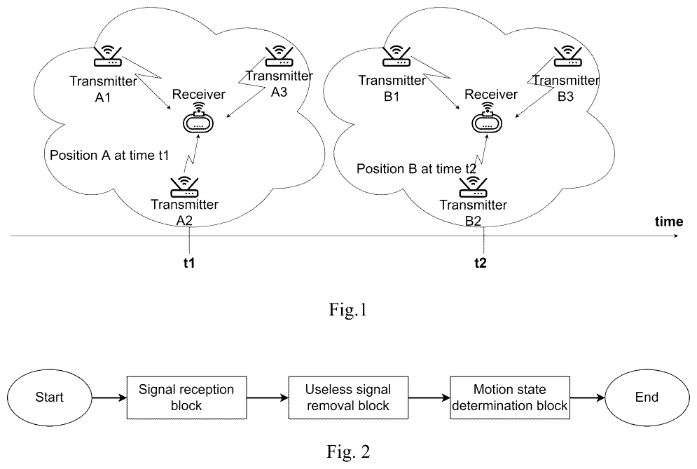

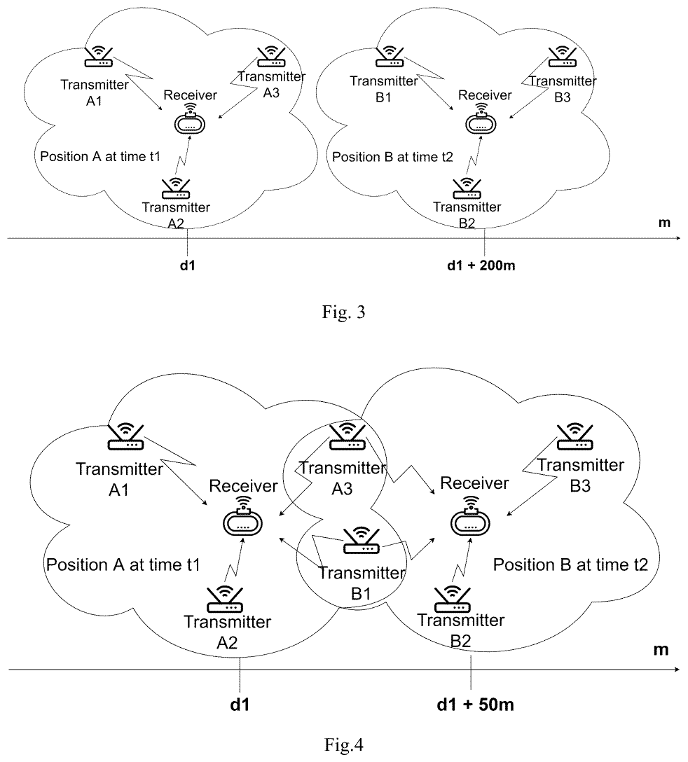

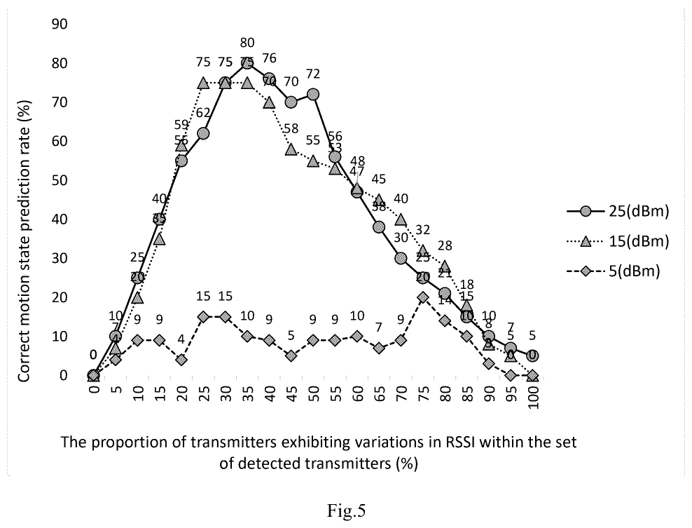

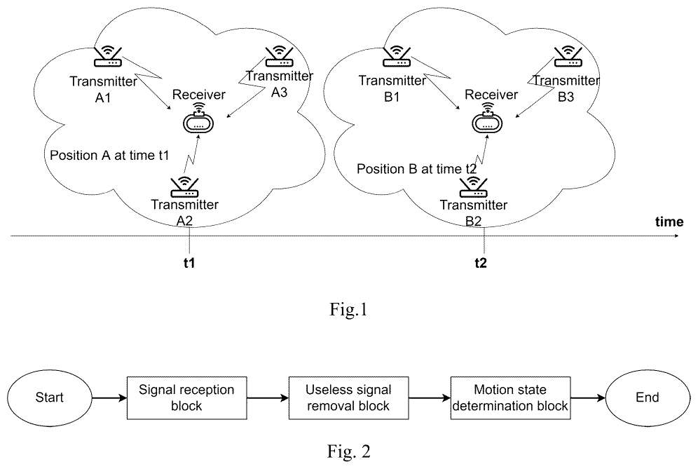

Referring to FIG. 1, suppose at time t1 the device is at location A and receives broadcast signals from access points A1, A2, and A3. Subsequently, at time t2, the device is at location B and receives broadcast signals from access points B1, B2, and B3. The change in the position of device leads to a change in the information about the access points received by the device. The solution proposes a complete system and flowchart to accurately determine the motion state of device. Referring to FIG. 2, the system includes the following blocks: the signal reception block, the useless removal block, and the motion state determination block. Specifically:

Signal reception block: this block performs two steps.

Step 1 involves scanning and receiving broadcast messages from surrounding access points. From these broadcast messages, two critical parameters are extracted for subsequent blocks:

Parameter one: access point identifier, typically the MAC address of the access point. Each access point has a unique MAC address, which is included in the broadcast messages.

Parameter two: the quality of the received signal at the device. Several metrics can measure this parameter, with the Received Signal Strength Indicator (RSSI) being the simplest and most effective. RSSI measures the strength of the signal the device can detect from the access point or router. It is a useful value for determining whether there is sufficient signal for a good wireless connection. A beneficial characteristic of RSSI for the purpose of system is that RSSI diminishes with increasing distance between the receiver and the transmitter.

Step 2 in the signal reception block involves storing the set of information about the access points just scanned into the memory of device. This memory can be RAM or ROM and is used for the subsequent motion state determination process.

### Useless Signal Removal Block:

After the device completes the signal reception, it will have two sets of access point information: the current set and the set stored from the previous scan. Within the set of received access point parameters, there may be parameters from access points that could interfere with the final results. For example, when using wireless network signals (WiFi) to determine motion, there could be cases where the wireless network source (e.g., a WiFi transmitter on a bus or from a mobile phone) moves with the device. Therefore, the solution incorporates an additional block for filtering out useless wireless signals. In the proposed solution, a useless wireless signal is defined as one where the access point parameters remain unchanged between three consecutive scan cycles, while the parameters of other access points show variations. Note that the MAC address of an access point is a fixed code that does not change, whereas the RSSI value is variable. Even if the device remains stationary, the RSSI values between two scans can differ, with an absolute difference in RSSI of less than 5 dBm considered insignificant. Thus, if the RSSI difference between two scans is less than 5 dBm, the access point parameter is considered unchanged. This is a pseudocode to determine and filter out useless signals.

Let t₀ be the current scan cycle, t₋₁ be the most recent scan cycle preceding t₀, and t₋₂ be the scan cycle preceding t₋₁. The method for identifying and removing useless signals is as follows:

Perform a loop to iterate through the elements (access point information) in the set of access points for cycle to. Each element in t₀ set is then compared sequentially with elements in the access point set for cycle t₋₁. If the element being examined in the t₀ set is found in the t₋₁ set, proceed to check if this element is also present in the access point set for cycle t₋₂. If the element is found in t₋₂ set, it is classified as a useless signal and should be removed from the t₀ set. Thus, useless signals can be regarded as the intersection of the access point sets across the three cycles to, t₋₁, t₋₂, for example:
W_{Current}: the set of access point parameters for the current cycle
W_{Previous_t}, W_{Previous_2}: the set of access point parameter for the two adjacent proceeding cycles
W_{Current}={{MAC_{A1}, RSSI_{A1}}, {MAC_{A2}, RSSI_{A2}}, . . . {MAC_{A6}, RSSI_{A6}}, . . . {MAC_{An}, RSSI_{A1}}}
W_{Previous_1}={{MAC_{B1}, RSSI_{B1}}, {MAC_{B2}, RSSI_{B2}}, . . . {MAC_{A6}, RSSI_{A6}}, . . . {MAC_{Bn}, RSSI_{Bn}}}
W_{Previous_2}={{MAC_{C1}, RSSI_{C1}}, {MAC_{C2}, RSSI_{C2}}, . . . {MAC_{A6}, RSSI_{A6}}, . . . {MAC_{Cn}, RSSI_{Cn}}}
W_{Current} ∩W_{Previous_1} ∩W_{Previous_2}={MAC_{A6}, RSSI_{A6}}
   ⇒{MAC_{A6}, RSSI_{A6}}represents the interfering radio signal parameters that need to be removed, resulting in the useful access point information set, which serves the motion determination calculation block.
W_{current}={{MAC_{A1}, RSSI_{A1}}, {MAC_{A2}, RSSI_{A2}}, . . . {MAC_{An}, RSSI_{An}}}
W_{Previous}={{MAC_{B1}, RSSI_{B1}}, {MAC_{B2}, RSSI_{B2}}, . . . {MAC_{Bn}, RSSI_{Bn}}}

### Motion State Determination Block:

After obtaining the access point information sets for the current and previous cycles, the next step involves the critical block responsible for determining the motion state. Two scenarios are considered:

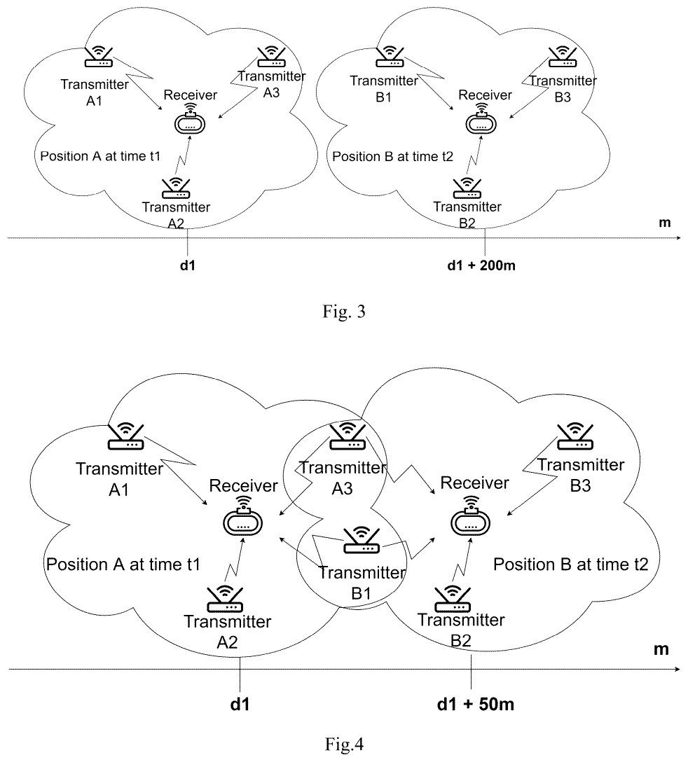

In the first case, referencing FIG. 3, if the device moves a significant distance between two scan cycles. This significant distance is at least equal to the maximum range within which an access point can broadcast a signal to the device, a parameter that depends on the radio technology used. In this case, if the device moves from point d₁ to d₁+200 m, it will no longer receive broadcast messages from the access points at point d₁. This leads to the formulation of the first condition:
(I) If the intersection of the current access point parameter set and the previous access point parameter set is empty, then the device has moved.

W_{Current}∩W_{Previous}=Ø

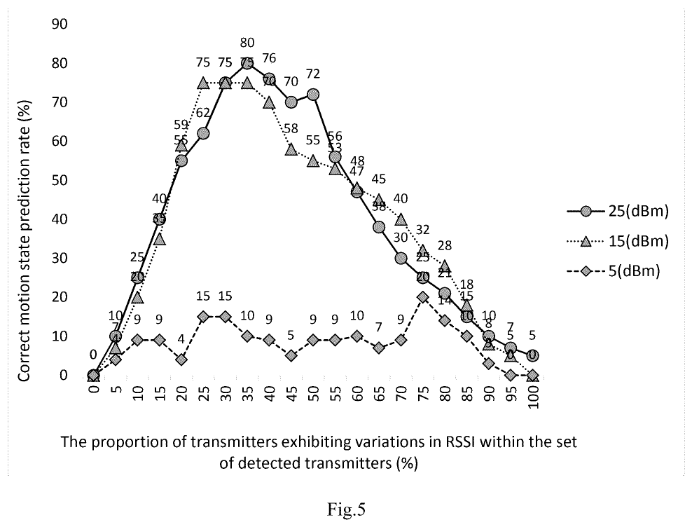

In the second case, refer to FIG. 4, if the device moves a short distance. In this scenario, after the device moves from point d₁ to point d₁+50 m, it is still able to receive broadcast messages from one or several access points that were previously detected at point d₁. To address this situation, we rely on the characteristic of the RSSI parameter, which decreases with distance; in other words, if the device moves closer to the source, the RSSI value will increase, and conversely, if the device moves farther from the source, the RSSI value will decrease. However, if the device moves from point A to point B between two cycles but the distance between the device and the access point remains unchanged, the RSSI result will also remain unchanged. Therefore, it is necessary to determine the proportion of access points that exhibit a change in RSSI (X %) among the detected access points. Using experimental methods, as shown in FIG. 5, which is a graph of the actual experimental results using WiFi technology. The vertical axis represents the proportion of correctly identified motion states over the total number of tests. The horizontal axis represents the parameter to be determined, which is the proportion of access points with a delta RSSI change over the total number of access points detected. From the graph in FIG. 5, it is observed that:
Choosing a delta RSSI close to 5 dBm results in a very low accuracy rate. The reason is even if the device is stationary, variations between scans can still occur with a delta of 5 dBm, as mentioned earlier.
Choosing a delta RSSI of 25 dBm achieves an accuracy rate of 80% with the proportion of access points showing a change in RSSI (delta RSSI=25 dBm) among the detected access points.

From the actual results, we give the second condition:
(II) If the proportion of access point parameters from the current WiFi scan that exhibit an RSSI difference of 25 dBm compared to the previous scan exceeds 30% of the total access points detected in the current scan, then the device has moved.

1. A system for detecting a motion state of a device based on radio signal information comprises three blocks:
a radio signal reception block: receives signals from access points, extracts MAC address and RSSI values, and stores them in memory;
a useless radio signal removal block: removes signals that could affect accuracy of a motion state determination from a set of detected access points;
a motion state determination block: compares and checks whether obtained WiFi access point sets meet predefined conditions to determine the motion state of device.

2. The system according to claim 1, wherein the radio signal reception block performs two steps:
step 1: scans and receives broadcast messages from surrounding access points; from these messages, extracts two important parameters for subsequent blocks, including: a first parameter is an access point identifier, typically a MAC address of the access point; a second parameter is a signal quality parameter received by the device, which can be measured by several metrics, with RSSI being the simplest and most effective;
step 2: stores a set of access point information obtained during the scan in a memory of the device, which can be either RAM or ROM, for use in the next motion state determination process.

3. The system according to claim 1, wherein in the useless radio signal removal block:
after completing the radio signal reception, the system obtains the current access point information set and the set of access point information saved from the previous scan, in the obtained access point parameter set, there may be parameters that could interfere with the final result, for instance, when using WiFi to determine motion, there may be cases where the access point itself moves with the device (e.g., a WiFi hotspot on a bus or a mobile phone hotspot), therefore, the solution includes an additional block to eliminate useless radio signals, in this solution, a useless radio signal is defined as one where the access point parameters remain unchanged across three consecutive cycles, while other access point parameters show variations, it is important to note that the MAC address of an access point is a fixed identifier, whereas RSSI values are variable, even if the device remains stationary, RSSI values between two scans can differ, with experimental results showing that the absolute difference in RSSI between two scans is less than 5 dBm, therefore, if the RSSI difference between two scans is less than 5 dBm, the access point parameter is considered unchanged.

4. The system according to claim 1, wherein in the motion state determination block, the predefined conditions for determining the motion state include:
if an intersection of the current access point parameter set and the previous access point parameter set is empty, then the device has moved;
if the proportion of access point parameters from the current scan with an RSSI difference of 25 dBm compared to the previous scan exceeds 30% of the total access points detected in the current scan, then the device has moved.
